(19) United States
(12) Patent Application Publication
(10) Pub. No.: US 2025/0208681 A1
(43) Pub. Date: Jun. 26, 2025

(54) EVENT-TRIGGERED DYNAMIC POWER MANAGEMENT

(71) Applicant: Advanced Micro Devices, Inc., Santa Clara, CA (US)

(72) Inventors: Heather Lynn Hanson, Austin, TX (US); Yasuko Eckert, Bellevue, WA (US); Rajagopalan Desikan, Austin, TX (US); Satvik Maurya, Austin, TX (US)

(73) Assignee: Advanced Micro Devices, Inc., Santa Clara, CA (US)

(21) Appl. No.: 18/324,808

(22) Filed: May 26, 2023

(51) Int. Cl. G06F 1/28; G06F 11/34

(52) U.S. Cl. CPC G06F 1/28; G06F 11/3495

(57) ABSTRACT

The disclosed device includes various components; and a control circuit for managing performance states of the components. The control circuit can receive an event trigger corresponding to one of the components, monitor an activity metric for the component, and update a performance state of the component based on the event trigger and the activity metric. Various other methods, systems, and computer-readable media are also disclosed.

### BACKGROUND

As computing systems become more complicated, managing various subsystems can become more challenging, often requiring dedicated control circuits. For example, a dynamic power management circuit can balance computing performance with power utilization. The dynamic power management circuit can observe, for a particular class of components, aggregate performance measures which can relate to bandwidth to determine appropriate performance states. However, such an aggregate view can be slow to respond to workload changes or can suppress more granular performance considerations.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary system for event-triggered dynamic power management.

FIG. 2 is a block diagram of an exemplary architecture of a dynamic power management system.

FIG. 3 is a block diagram of an exemplary architecture of an event-triggered dynamic power management system.

FIG. 4 is a flow diagram of an exemplary arbitration by a dynamic power management system.

FIG. 5 is a flow diagram of an exemplary arbitration by an event-triggered dynamic power management system.

FIG. 6 is a flow diagram of an exemplary method for event-triggered dynamic power management.

FIG. 7 is a flow diagram of an exemplary method for event-triggered dynamic power management.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to event-triggered dynamic power management. As will be explained in greater detail below, implementations of the present disclosure include a controller or control circuit that can manage performance states of various components by receiving an event trigger relating to a component, monitoring an activity metric relating to the component, and updating a performance state of the component based on the event trigger and the activity metric. The control circuit can advantageously react more readily to event triggers, and more effectively consider the event triggers for managing performance states. The control circuit can also make more granular decisions regarding performance states (e.g., updating at least a subset of a class of components rather than applying broad performance state updates).

In one implementation, a device for event-triggered dynamic power management includes a plurality of components, and a control circuit configured to manage performance states for the plurality of components by: (i) receiving an event trigger corresponding to a component, (ii) monitoring an activity metric corresponding to at least one of the plurality of components, and (iii) updating a performance state of the component based on the event trigger and the activity metric.

In some examples, the activity metric corresponds to an aggregate bandwidth of one or more of the plurality of components and the control circuit is configured to update the performance state by (a) increasing the performance state of the component in response to the activity metric indicating available aggregate bandwidth, (b) decreasing the performance state of the component in response to the activity metric indicating limited aggregate bandwidth, and (c) maintaining the performance state of the component in response to the activity metric indicating boundedness based on a dependency of another component.

In some examples, the control circuit is configured to override, in response to the event trigger, the update responding to the activity metric. In some examples, the control circuit is configured to override the update responding to the activity metric by changing the performance state based on the event trigger when the activity metric indicates maintaining the performance state. In some examples, the control circuit is configured to determine the aggregate bandwidth by comparing a message queue size with a bandwidth threshold.

In some examples, the control circuit is configured to modify a step size of performance state changes in response to the event trigger. In some examples, the control circuit is configured to suspend performance state changes in response to the event trigger.

In some examples, the plurality of components includes one or more component classes. In some examples, the one or more component classes includes at least one of: compute units, links, or remote memory. In some examples, updating the performance state of the component comprises updating at least a subset of a component class.

In some examples, the control circuit is configured to send a high priority message to a related component in response to the event trigger.

In one implementation, a system for event-triggered dynamic power management includes a plurality of components comprising a plurality of compute units, a plurality of links, and a plurality of remote memory. The system also includes a control circuit configured to manage performance states for a component class of the plurality of components by (i) determining a performance state of the component class based on an activity metric corresponding to at least one of the plurality of components, (ii) receiving an event trigger corresponding to the component class, and (iii) updating the performance state by factoring the event trigger with the activity metric.

In some examples, the activity metric corresponds to an aggregate bandwidth of the component class and the control circuit is configured to update the performance state by (a) increasing the performance state of the component class in response to the activity metric indicating available aggregate bandwidth, (b) decreasing the performance state of the component class in response to the activity metric indicating limited aggregate bandwidth, and (c) maintaining the performance state of the component class in response to the activity metric indicating boundedness based on a dependency of another component.

In some examples, the control circuit is configured to override, in response to the event trigger, the update responding to the activity metric. In some examples, the control circuit is configured to modify a step size of performance state changes in response to the event trigger. In some examples, the control circuit is configured to suspend performance state changes in response to the event trigger. In some examples, updating the performance state of the component class comprises updating at least a subset of the component class. In some examples, the control circuit is configured to send a high priority message to another component class in response to the event trigger.

In one implementation, a method for event-triggered dynamic power management includes (i) receiving, by a control circuit configured to manage a performance state of a component using an activity metric, an event trigger corresponding to the component, (ii) adjusting a weight of the event trigger with respect to a weight of the activity metric, and (iii) updating the performance state based on the adjusted weights.

In some examples, the performance state based on the adjusted weights overrides a performance state before adjusting the weights.

Features from any of the implementations described herein can be used in combination with one another in accordance with the general principles described herein. These and other implementations, features, and advantages will be more fully understood upon reading the following detailed description in conjunction with the accompanying drawings and claims.

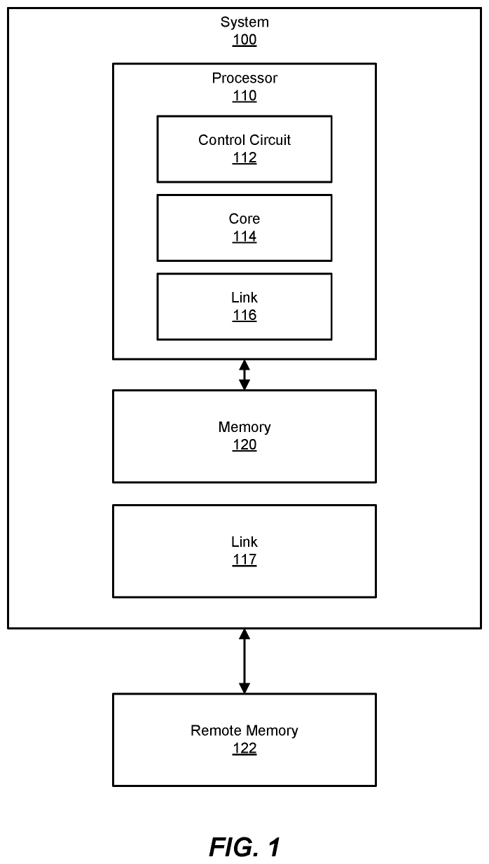

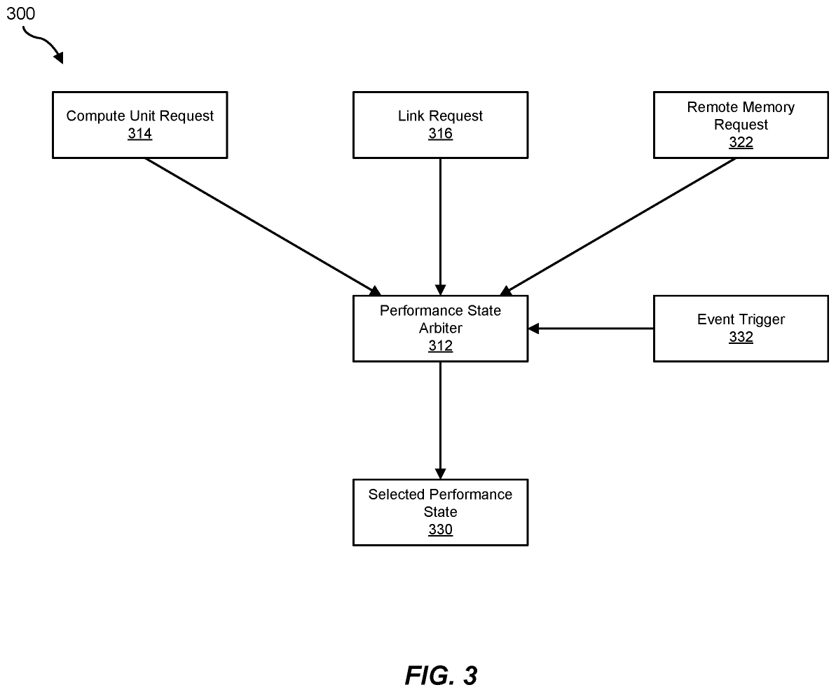

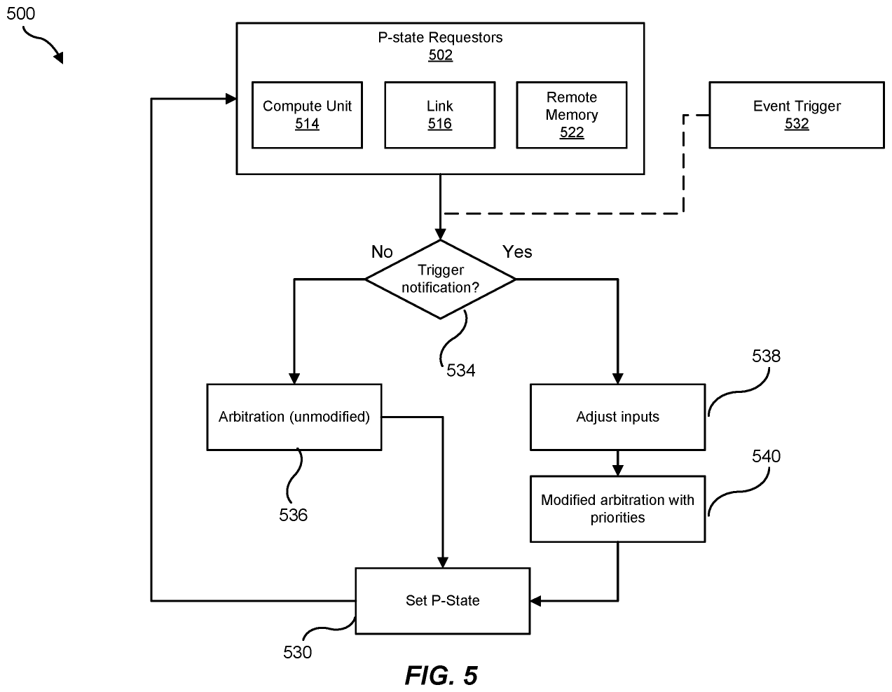

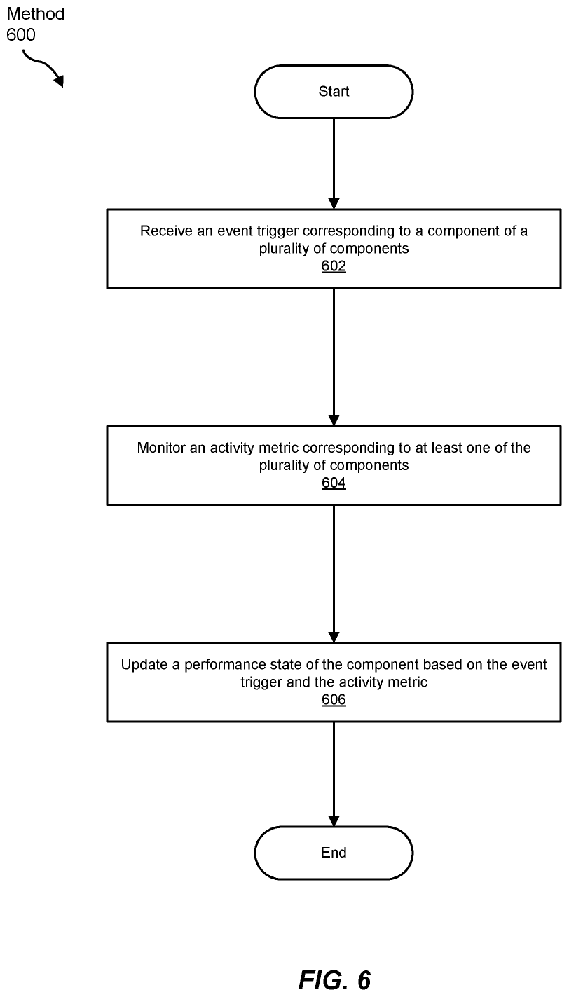

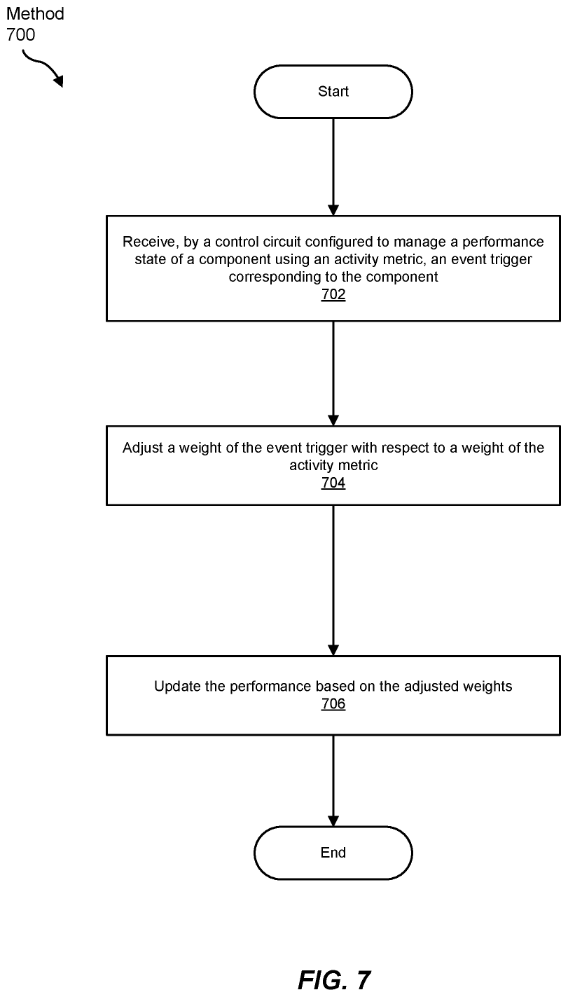

The following will provide, with reference to FIGS. 1-7, detailed descriptions of event-triggered dynamic power management. Detailed descriptions of example systems for dynamic power management will be provided in connection with FIGS. 1, 2, and 4. Detailed descriptions of example flows for dynamic power management will be provided in connection with FIGS. 3 and 5. Detailed descriptions of corresponding methods will also be provided in connection with FIGS. 6 and 7.

FIG. 1 is a block diagram of an example system 100 for event-triggered dynamic power management. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110. Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, chiplets (e.g., smaller and in some examples more specialized processing units that can coordinate as a single chip), microprocessors, microcontrollers, Central Processing Units (CPUs), graphics processing units (GPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, graphics processing units (GPUs), portions of one or more of the same, variations or combinations of one or more of the same, and/or any other suitable physical processor.

As further illustrated in FIG. 1, processor 110 includes a core 114 corresponding to one or more cores, chiplets, compute units, etc. Processor 110 also includes a link 116 (e.g., on core) and system 100 includes a link 117 (e.g., off core) each corresponding to communication-related components such as one or more links, interfaces, memory controllers, local memory (e.g., dual in-line memory module (DIMM)), data fabrics, etc., for interconnecting components (e.g., peripheral devices and other connected devices) and facilitate communication of data. System 100 is further coupled to a remote memory 122, corresponding to a memory device remote to system 100, such as a fabric attached memory, memory-semantic fabric, remote memory attach, etc. In addition, processor 110 includes a control circuit 112, corresponding to a circuit for dynamic power management. Each component can further include or connect to a corresponding data fabric, which corresponds to various interconnects and data channels and related control circuits.

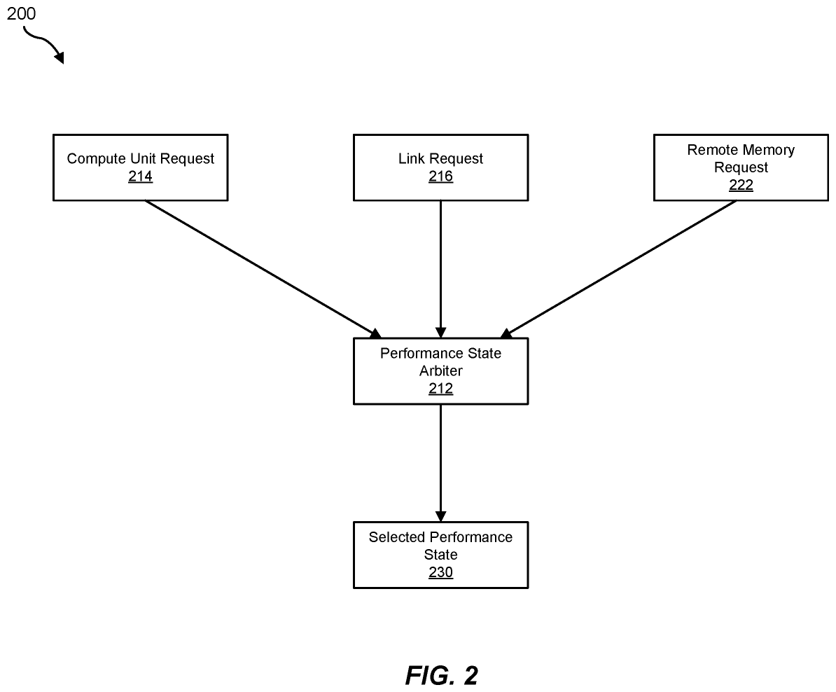

FIG. 2 illustrates an example data flow diagram 200 of dynamic power management via performance state arbitration. A performance state for a component/class of components can correspond to a level of performance (e.g., ranging from various levels from low to high) which can further correspond to power utilization. For instance, at a high performance level, a component can consume more power (e.g., drawing more current, operating at a higher/faster frequency, having more activated components/links, etc.). Conversely, at a low performance level, the component can consume less power (e.g., drawing less current, operating at a lower/slower frequency, etc.). Although performance states (also referred to as P-states herein) are not necessarily directly translatable to power consumption, for the purposes of simplifying the discussion herein, P-states can be referred to power consumption levels. In addition, for the purposes of discussion herein, a higher performance state can correspond to a performance state with higher performance and/or frequency, and a lower performance state can correspond to a performance state with lower performance and/or frequency, regardless of how performance states can be indexed in various implementations. Accordingly, a dynamic power management system can manage P-states of components as a way of managing power consumption.

In FIG. 2, a performance state arbiter 212 (corresponding to control circuit 112) can manage performance states of various components and/or classes of components, such as compute units (e.g., a core complex comprising multiple cores and/or individual cores), links for various devices, links for memory, and/or data fabrics for each component. In some examples, each managed component can request a performance state, such as a specific performance state and/or a change in performance state (e.g., an increased state or a decreased state). For example, performance state arbiter 212 can receive a compute unit request 214 (corresponding to a P-state request from core 114 and/or a data fabric thereof), a link request 216 (corresponding to link 116, link 117, and/or a data fabric thereof), and/or a remote memory request 222 (corresponding to remote memory 122 and/or a data fabric thereof). In some examples, the request can correspond to a predicted best choice of P-state for the specific component/unit. Performance state arbiter 212 can observe one or more activity metrics such as performance counters (e.g., registers holding values that are updated during runtime and/or values provided by state machines), aggregate metrics (e.g., aggregating multiple counters into a single value), metrics from other components (e.g., an aggregate memory bounded counter along with values from other registers in cores and/or core complexes), etc. to determine whether the requested change is feasible (e.g., sufficient power resources are available) and/or appropriate (e.g., will potentially provide a performance boost or free up resources). Performance state arbiter 212 can accordingly select a selected performance state 230 for the overall data fabric (e.g., by applying the requested P-states when appropriate). Selected performance state 230 can be selected to be reasonable and beneficial given the various factors (e.g., activity metrics) considered.

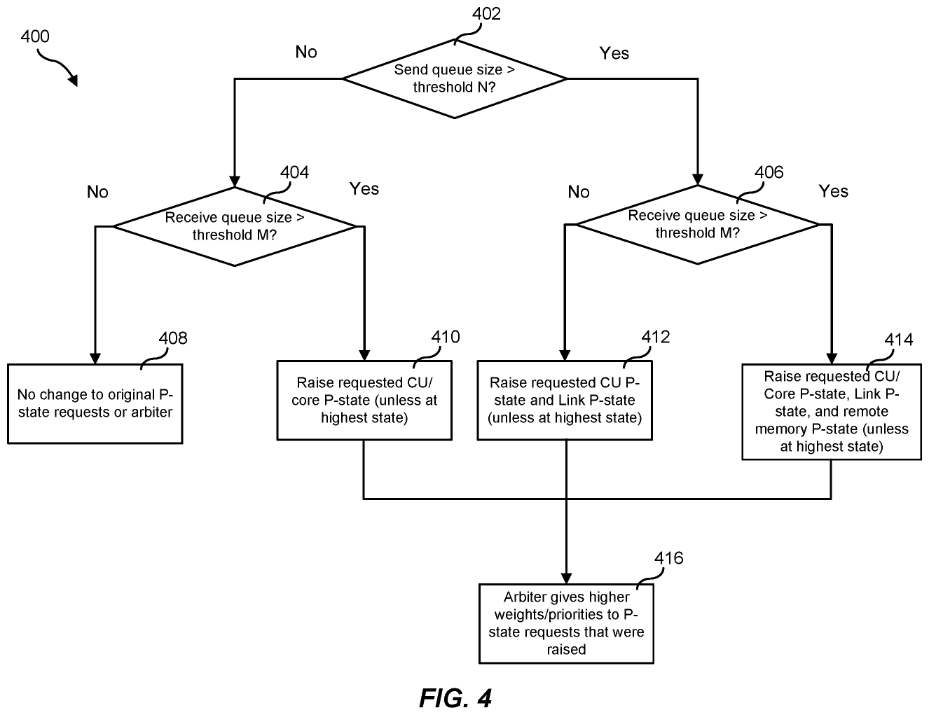

FIG. 3 illustrates an example data flow diagram 300 of event-triggered dynamic power management via performance state arbitration. Similar to FIG. 2, a performance state arbiter 312 (corresponding to control circuit 112) can manage performance states of various components and/or classes of components, such as compute units (e.g., a core complex comprising multiple cores and/or individual cores), links for various devices, links for memory, and/or data fabrics for each component. Also similar to FIG. 2, each managed component can request a performance state, such as a specific performance state and/or a change in performance state (e.g., an increased state or a decreased state). For example, performance state arbiter 312 can receive a compute unit request 314 (corresponding to a P-state request from core 114 and/or a data fabric thereof), a link request 316 (corresponding to link 116, link 117, and/or a data fabric thereof), and/or a remote memory request 322 (corresponding to remote memory 122 and/or a data fabric thereof). In some examples, the request can correspond to a predicted best choice for the specific component/unit, which can correspond to an increased or decreased performance state as compared to a current performance state. However, in contrast to FIG. 2, performance state arbiter 312 can observe various metrics such as activity metrics as well as an event trigger 332 to determine whether the requested change is feasible and/or appropriate. Performance state arbiter 312 can increase P-state requests (e.g., applying a modification or boost to the original P-state request) when event trigger 332 indicates an opportunity for more performance, such as more responsive communication, or use standard requests (e.g., applying no modification or boost to the original P-state request). An event trigger corresponds to a lightweight communication for sending notifications for relevant events, which can facilitate a quick, informed response by performance state arbiter 312. Performance state arbiter 312 can accordingly select a selected performance state 330 for the overall data fabric, as will be explained further with respect to FIG. 4.

FIG. 4 illustrates an example flow diagram 400 of an arbitration for remote memory message transactions by a dynamic power management system, such as control circuit 112 and/or performance state arbiter 312. FIG. 4 illustrates arbitration using activity metrics relating to message queues, such as for a remote memory, although in other examples can relate to other data fabrics using queues for sending and receiving messages.

In this example, the send and receive queues have independent occupancy thresholds, e.g., a threshold N for the send queue and a threshold M for the receive queue, and the respective queue sizes can be sent as one or more event triggers (e.g., event trigger 332). If both queues are below their respective thresholds (e.g., send queue size is not greater than N at 402, and receive queue size is not greater than M at 404), the arbiter (e.g., performance state arbiter 312) can follow a standard policy (e.g., no boost to the P-state requests at 408).

If either of the queues contain more entries than their respective threshold, appropriate individual requests can be boosted to give more emphasis to the relevant components during the decision process, as illustrated in FIG. 4. For instance, if the send queue size is not greater than N (at 402) and the receive queue size is greater than M (at 404), at 410 the arbiter can raise the requested compute unit/core P-state (e.g., compute unit request 314, which in some examples can correspond to a set of cores and/or one or more individual cores) unless the request is already at the highest state. If the send queue size is greater than N (at 402) and the receive queue size is not greater than M (at 406), at 412 the arbiter can raise the requested compute unit P-state (e.g., compute unit request 314) and a requested link P-state (e.g., link request 316) unless the request is already at the highest state. If the send queue size greater than N (at 402) and the receive queue size is greater than M (at 406), at 414 the arbiter can raise the requested compute unit P-state (e.g., compute unit request 314, which in some examples can correspond to a set of cores and/or one or more individual cores), the requested link P-state (e.g., link request 316), and a requested remote memory P-state (e.g., remote memory request 322), unless the request is already at the highest state.

Accordingly, in cases when individual requests are boosted, the arbiter decision process can be modified to give higher precedence to the boosted components, effectively amplifying the effect of the event trigger within the controller. Thus, at 416, the arbiter can give higher weights/priorities to P-state requests that were raised/boosted to determine performance states (e.g., selected performance state 330).

In some implementations, the arbiter can increase data fabric frequencies (when there is headroom to do so) to proactively process incoming messages, or send high-priority messages to other cores, even when CPU cores are not yet memory bound (e.g., waiting on responses from memory). When the send and receive queues are below their respective thresholds, the standard requests from each component can lower the frequency to meet application demands.

In some implementations, event triggers can be used to modify the step size when the arbiter chooses a new setting, such as jumping up or down by more than one P-state per decision, instead of a single step up or down.

In some implementations, event triggers can be used to override the arbiter's initial choice with an immediate P-state change. For example, the arbiter can be constrained to periodic changes, having a wait time between changes to avoid dithering. The event trigger can override this wait time, although additional logic to detect negative side effects from excessive dithering can further be incorporated.

In some implementations, event triggers could be used as a freeze mechanism to prevent or otherwise suspend a P-state change. For instance, in some situations a blackout period that occurs with each P-state transition can negatively impact performance. Preventing the P-state change can avoid this blackout period.

Although FIG. 4 illustrates example activity metrics relating to message queues, in other examples, other activity metrics (e.g., relating to bandwidth, workload, etc.) can be used.

FIG. 5 illustrates an example data flow diagram 500 of event-triggered dynamic power management performance state arbiter such as performance state arbiter 312 and/or control circuit 112. P-state requestors 502, which can include various components and/or classes of components, such as compute unit 514 (e.g., a core complex comprising multiple cores and/or individual cores and corresponding to core 114 and/or a data fabric thereof), link 516 for various devices (corresponding to link 116, link 117, and/or a data fabric thereof), and a remote memory 522 (corresponding to remote memory 122 and/or a data fabric thereof).

In one example, the arbiter can evaluate incoming requests (which in some implementations can be generated periodically such as every millisecond) and honor the highest P-state that is requested by any entity (e.g., from P-state requestors 502) in the system. All the entities in the system can start with a low performance P-state request and increase their requests as they need higher performance. When their respective activity metrics drop below thresholds for requesting higher performance, the entities can reduce requested P-states and/or stop sending P-state requests.

For example, link 516 can use different bandwidth (B/W) thresholds to request a higher performance P-state. Once the B/W goes above this threshold, link 516 can request a higher P-state (e.g., at 534). When the B/W goes below this threshold, link 516 can request a lower P-state. Thus, the request by link 516 for P-states can fluctuate with higher and lower P-states through time, according to observed B/W.

If at 534 the arbiter receives an event trigger 532 that can increase the request from link 516, the arbiter can modify the request at 538 for instance by increasing/boosting the requested P-state. At 540, the arbiter can perform modified arbitration with priorities. For example, the arbiter can choose the P-state based on the set requests, giving priority to entities with modified requests. In some examples, when the P-state requests are sufficiently lower than the current P-state such that the boosted request is also lower than the current P-state, the arbiter can decrement the P-state despite the boost.

If at 534 the arbiter does not receive a trigger notification, the arbiter can choose the P-state according to unmodified arbitration (e.g., with unmodified requests) at 536, which can naturally decrease (and increase) P-state values through time based on entity requests according to its original inputs. For instance, the arbiter can decrement the P-state when the original inputs (e.g., P-state requests) are lower than the current P-state.

As described herein, certain aspects of the arbitration can be modified, for example, to consider updated priorities in response to event trigger 532. Other aspects of the arbitration include considering factors such as boundedness of a corresponding activity of a requestor. If a change in P-state is not expected to materially affect an overall throughput, the requested P-state change can be ignored. For example, if a compute unit is memory bounded (e.g., is waiting for data from memory that can be stalled due to memory bandwidth limitations), the corresponding request can reflect an aggregate view of memory boundedness across all cores. However, event trigger 532 can indicate or otherwise request a higher P-state for a subset of cores that can be executing high-priority tasks and whose performance can be improved with the higher P-state despite a calculation of low average memory across all cores. In some examples, the arbiter can respond with selecting the higher P-state for the requested subset of cores. In other examples (e.g., implementations in which a set of cores are linked to the same P-state), the arbiter can respond with selecting, if feasible, a higher P-state (e.g., as requested or an intermediary P-state) for the corresponding set of cores, including the requested subset of core. However, in some examples, the arbiter can ignore the request if a higher P-state for the cores is not feasible. In some examples, event trigger 532 can be triggered in response to additional criteria in order to screen for additional dependencies that can bound performance.

After completing the arbitration, either with event trigger 532 or without, the arbiter can set the appropriate P-state at 530 for P-state requestors 502. With the updated P-states, P-state requestors 502 can accordingly generate new requests.

FIG. 6 is a flow diagram of an exemplary method 600 for event-triggered dynamic power management. The steps shown in FIG. 6 can be performed by any suitable circuit, code and/or computing system, including the system(s) illustrated in FIGS. 1 and/or 3. In one example, each of the steps shown in FIG. 6 represent an algorithm whose structure includes and/or is represented by multiple sub-steps, examples of which will be provided in greater detail below.

As illustrated in FIG. 6, at step 602 one or more of the systems described herein receive an event trigger corresponding to a component of a plurality of components. For example, control circuit 112 can receive an event trigger corresponding to one or more of core 114, link 116, link 117, and remote memory 122.

The systems described herein can perform step 602 in a variety of ways. In one example, the plurality of components includes one or more component classes, such as compute units (e.g., core 114), links (e.g., link 116 and/or link 117), or remote memory (e.g., remote memory 122). In some examples, the event trigger can correspond to a component class and/or a subset thereof.

At step 604 one or more of the systems described herein monitor an activity metric corresponding to at least one of the plurality of components. For example, control circuit 112 can monitor an activity metric corresponding to the component.

The systems described herein can perform step 604 in a variety of ways. In one example, the activity metric corresponds to an aggregate bandwidth of one or more of the plurality of components.

At step 606 one or more of the systems described herein update a performance state of the component based on the event trigger and the activity metric. For example, control circuit 112 can update a performance state of the component based on the event trigger and the activity metric.

The systems described herein can perform step 606 in a variety of ways. In one example, the control circuit can be configured to update the performance state by increasing the performance state of the component in response to the activity metric indicating available aggregate bandwidth, decreasing the performance state of the component in response to the activity metric indicating limited aggregate bandwidth, and/or maintaining the performance state of the component in response to the activity metric indicating boundedness based on a dependency of another component. In some examples, the control circuit is configured to determine the aggregate bandwidth by comparing a message queue size with a bandwidth threshold (see, e.g., FIG. 4).

In some examples, the control circuit can be configured to override, in response to the event trigger, the update responding to the activity metric. For instance, the control circuit can override the update responding to the activity metric by changing the performance state based on the event trigger when the activity metric indicates maintaining the performance state (see, e.g., FIG. 5).

The control circuit can also perform supplementary actions in addition to changing requested performance states and/or modifying weights. For instance, the control circuit can modify a step size of performance state changes in response to the event trigger. In some examples, the control circuit can suspend performance state changes in response to the event trigger. In some examples, the control circuit can send a high priority message to a related component in response to the event trigger. Moreover, updating the performance state of the component can include updating a subset of a corresponding component class.

In some examples, the control circuit (and/or performance state arbiter) can manage or maintain performance states via a bit value and/or data value that can be stored in a memory device (e.g., register or other memory) that is incorporated in and/or interfaces with the control circuit such that updating a performance state can include modifying this bit/data value.

In some examples, the control circuit can correspond to a state machine (e.g., including circuitry for the state machine) that updates its states when updating performance states as described herein. In some examples, the control circuit can select, based on the factors as described herein, an appropriate performance state from a table or list of available performance states in response to a request for a performance state such that updating a performance state includes returning a most updated selection of performance state in response to a request.

FIG. 7 is a flow diagram of an exemplary method 700 for event-triggered dynamic power management. The steps shown in FIG. 7 can be performed by any suitable circuit, code and/or computing system, including the system(s) illustrated in FIGS. 1 and/or 3. In one example, each of the steps shown in FIG. 7 represent an algorithm whose structure includes and/or is represented by multiple sub-steps, examples of which will be provided in greater detail below.

As illustrated in FIG. 7, at step 702 one or more of the systems described herein receive, by a control circuit configured to manage a performance state of a component using an activity metric, an event trigger corresponding to the component. For example, control circuit 112 receives an event trigger corresponding to a component (e.g., one or more of core 114, link 116, link 117, and remote memory 122).

At step 704 one or more of the systems described herein adjust a weight of the event trigger with respect to a weight of the activity metric. For example, control circuit 112 can adjust a weight of the event trigger with respect to a weight of the activity metric (see, e.g., FIG. 5).

At step 706 one or more of the systems described herein update the performance state based on the adjusted weights. For example, control circuit 112 can update the performance state based on the adjusted weights (see, e.g., FIG. 5).

The systems described herein can perform step 706 in a variety of ways. In one example, the performance state based on the adjusted weights can override a performance state before adjusting the weights.

As detailed above, a dynamic power management (DPM) system can attempt to optimize total throughput while enforcing socket-level power limits. In one example, a DPM can increase data fabric (DF) frequencies when specific activity metrics indicate that data fabric communication is a performance bottleneck, and can decrease those frequencies to provide more power budget to CPU cores when it does not detect memory-related bottlenecks.

Dynamic power managers often have limited visibility into key runtime information. For instance, some power management systems employ offline power and performance models in conjunction with runtime activity metric observations to provide some visibility into current conditions. However, it is difficult to infer all critical high-level application semantics by sampling a small set of activity metrics.

For instance, each data fabric DPM can set memory- and link-related clock frequencies for its socket based on observed (prior) behavior, without the benefit of important information such as incoming messages, priorities among workloads, critical paths within workloads, performance sensitivity to actions beyond the socket, and more. With its limited visibility, a DPM can cause workload execution to “hurry up and wait” for bulk synchronization points (wasting power budget) or miss performance opportunities by waiting for SoCs to become sufficiently memory bound before raising data fabric frequencies. Additionally, the DPM system can miss detecting low-bandwidth but latency-critical messages over certain links.

In other words, the DPM system is similar to a traffic control system using real-time traffic congestion on a city map based on observed travel times. Timely alerts for specific features, such as alerts for impending weather conditions, lane closures, construction activity, crash sites, a large bolus of traffic after an event, etc. can provide the traffic control system with useful information that can allow the traffic control system to take action based on the combination of general traffic congestion data and new alerts. Leveraging both run-time aggregate information and incident-specific information as described herein can provide unique opportunities to improve controller response.

Thus, DPM systems can benefit from additional, timely information to refine its frequency choices and proactively adjust settings to better meet workload demands. The systems and methods described herein provide an additional input type (e.g., event triggers) to provide critical information for power management. Event triggers provide the opportunity for a power manager to take action proactively based on alerts for specific important events, rather than waiting for bottlenecks to occur. By incorporating event triggers in conjunction with existing activity metrics, the systems and methods described herein advantageously provide valuable insight to refine power management decisions in power-constrained, performance-critical situations. The responsive control options can also provide higher performance and potentially improved power and energy efficiency for large-scale computing, with minimal additional cost.

The systems and methods described herein provides mechanisms to monitor and detect event triggers. An event trigger corresponds to a lightweight mechanism to send notifications for relevant events, to facilitate a quick, informed response. Adding event triggers to the decision process for power and performance settings allows proactively adjusting P-state settings in accordance with both standard requests and novel event triggers. For instance, event triggers can be used to selectively boost the DF P-state when opportunities arise for higher performance.

In one example involving remote memory, network message transactions events can be triggered (see, e.g., FIG. 4), although can be applied to other events (e.g., checkpointing in remote memory) that can impact the utilization of cores and SoC components.

For remote memory, a CPU typically uses send (or transmit) and receive queues to signal the network interface card (NIC) that there are messages to send and receive. These queues may be mapped to specific address regions of the main memory. Memory controllers can monitor the arrival of new messages (e.g., via event triggers) and the number of messages in the send and receive queues with a small amount of additional logic (similar to a performance monitoring unit in a memory controller), and record the queue occupancy rates in remote counters.

Event trigger mechanisms can be designed to notify other components about specific events of interest, which can be intermittent or widely spaced in time. In contrast, counter data can be continuously accumulated throughout a sampling time, often aggregated together to form an overall sum. Thus, event triggers differ from counters and other data collected from register in the immediate, discrete nature of defined events and how the trigger information impacts controller decisions.

DF P-states define the clock frequencies for the Dynamic Random Access Memory (DRAM) double data rate (DDR) memories, memory controller, and data fabric logic; higher p-states correspond to higher clock frequencies, and lower p-states indicate lower frequencies. In power-constrained environments, higher frequencies in the data fabric can translate into a reduced power budget with reduced core clock frequencies. It is critical for the Data Fabric Performance State (DFPS) Arbiter to balance the needs of communication and computation for overall throughput performance, and it adjusts the DF P-state higher and lower throughout workload execution, striving to tailor the DF P-states to current workload conditions based on prior observations. In some implementations, the arbiter can be limited to choosing a new setting periodically. To avoid dithering, the systems and methods provided herein can adhere to this periodic choosing.

As detailed above, the circuits, computing devices and systems described and/or illustrated herein broadly represent any type or form of computing device or system capable of executing computer-readable instructions, and/or components thereof. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the modules and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more modules stored in the above-described memory device. Examples of physical processors include, without limitation, microprocessors, microcontrollers, Central Processing

Units (CPUs), Field-Programmable Gate Arrays (FPGAs) that implement softcore processors, Application-Specific Integrated Circuits (ASICs), systems on a chip (SoCs), digital signal processors (DSPs), Neural Network Engines (NNEs), accelerators, graphics processing units (GPUs), portions of one or more of the same, variations or combinations of one or more of the same, or any other suitable physical processor.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a plurality of components; and
a control circuit configured to manage performance states for the plurality of components by:
receiving an event trigger corresponding to a component;
monitoring an activity metric corresponding to at least one of the plurality of components; and
updating a performance state of the component based on the event trigger and the activity metric.

2. The device of claim 1, wherein the activity metric corresponds to an aggregate bandwidth of one or more of the plurality of components and the control circuit is configured to update the performance state by:
increasing the performance state of the component in response to the activity metric indicating available aggregate bandwidth;
decreasing the performance state of the component in response to the activity metric indicating limited aggregate bandwidth; and
maintaining the performance state of the component in response to the activity metric indicating boundedness based on a dependency of another component.

3. The device of claim 2, wherein the control circuit is configured to override, in response to the event trigger, the update responding to the activity metric.

4. The device of claim 3, wherein the control circuit is configured to override the update responding to the activity metric by changing the performance state based on the event trigger when the activity metric indicates maintaining the performance state.

5. The device of claim 2, wherein the control circuit is configured to determine the aggregate bandwidth by comparing a message queue size with a bandwidth threshold.

6. The device of claim 1, wherein the control circuit is configured to modify a step size of performance state changes in response to the event trigger.

7. The device of claim 1, wherein the control circuit is configured to suspend performance state changes in response to the event trigger.

8. The device of claim 1, wherein the plurality of components includes one or more component classes.

9. The device of claim 8, wherein the one or more component classes includes at least one of:
compute units;
links; or
remote memory.

10. The device of claim 8, wherein updating the performance state of the component comprises updating at least a subset of a component class.

11. The device of claim 1, wherein the control circuit is configured to send a high priority message to a related component in response to the event trigger.

12. A system comprising:
a plurality of components comprising:
a plurality of compute units;
a plurality of links; and
a plurality of remote memory; and
a control circuit configured to manage performance states for a component class of the plurality of components by:
determining a performance state of the component class based on an activity metric corresponding to at least one of the plurality of components;
receiving an event trigger corresponding to the component class; and
updating the performance state by factoring the event trigger with the activity metric.

13. The system of claim 12, wherein the activity metric corresponds to an aggregate bandwidth of the component class and the control circuit is configured to update the performance state by:
increasing the performance state of the component class in response to the activity metric indicating available aggregate bandwidth;
decreasing the performance state of the component class in response to the activity metric indicating limited aggregate bandwidth; and
maintaining the performance state of the component class in response to the activity metric indicating boundedness based on a dependency of another component.

14. The system of claim 13, wherein the control circuit is configured to override, in response to the event trigger, the update responding to the activity metric.

15. The system of claim 12, wherein the control circuit is configured to modify a step size of performance state changes in response to the event trigger.

16. The system of claim 12, wherein the control circuit is configured to suspend performance state changes in response to the event trigger.

17. The system of claim 12, wherein updating the performance state of the component class comprises updating at least a subset of the component class.

18. The system of claim 12, wherein the control circuit is configured to send a high priority message to another component class in response to the event trigger.

19. A method comprising:
receiving, by a control circuit configured to manage a performance state of a component using an activity metric, an event trigger corresponding to the component;
adjusting a weight of the event trigger with respect to a weight of the activity metric; and
updating the performance state based on the adjusted weights.

20. The method of claim 19, wherein the performance state based on the adjusted weights overrides a performance state before adjusting the weights.
